(19) United States
(12) Patent Application Publication
(10) Pub. No.: US 2006/0234105 A1
(43) Pub. Date: Oct. 19, 2006

(54) Stack and fuel cell system having the same

(76) Inventor: Dong-Myung Suh, Suwon-si (KR)

Correspondence Address: CHRISTIE, PARKER & HALE, LLP, PO BOX 7068, PASADENA, CA, 91109-7068, US

(21) Appl. No.: 11/404,475

(22) Filed: Apr. 13, 2006

(30) Foreign Application Priority Data
Apr. 13, 2005 (KR) 10-2005-0030663

(51) Int. Cl. H01M 8/02; H01M 8/10; H01M 8/24; H01M 8/06

(52) U.S. Cl. 429/34; 429/30; 429/32; 429/19

(57) ABSTRACT

A stack for a fuel cell system including at least one electricity generation unit. The at least one electricity generation unit includes a membrane-electrode assembly and a separator disposed on at least one planar surface of the membrane-electrode assembly. The at least one electricity generation unit has an input end and an output end. An input end plate and an output end plate are disposed adjacent to the input end and the output end, respectively, the input end plate and the output end plate having reinforcement ribs formed on a surface.

### CROSS-REFERENCE TO RELATED APPLICATION

This application claims priority to and the benefit of Korean Patent Application No. 10-2005-0030663 filed in the Korean Intellectual Property Office on Apr. 13, 2005, the entire content of which is incorporated herein by reference.

### BACKGROUND OF THE INVENTION

1. Field of the Invention

The present invention relates to a fuel cell system, and more particularly, to a fuel cell system having a stack with increased resistance to bending.

2. Description of the Related Art

A fuel cell system is an electricity generating system that directly converts chemical reaction energy of hydrogen contained in a hydrocarbon material such as methanol, and oxygen or air containing oxygen into electrical energy.

This fuel cell system uses reformed hydrogen made from methanol, ethanol, or the like as fuel and has a wide range of applications, including as a mobile power source for vehicles, as a distributed power source for homes or buildings, and as a small-sized power source for electronic apparatuses.

Each unit cell of the fuel cell system includes a membrane electrode assembly (MEA) generating electricity by an oxidation-reduction reaction of the hydrogen and the oxygen, and a separator, also called a bipolar plate, that is disposed in contact with a generally planar surface of the MEA and supplies hydrogen and oxygen to the MEA. A stack is formed by multi-layering a plurality of unit cells.

The stack has a structure in which separate pressure plates made of metal are disposed in contact with an outermost separator. The pressure plates are tightened by fastening nuts and bolts after current-collecting plates have been inserted between the outermost separators and the pressure plates.

However, in a conventional fuel cell system, deformation of the pressure plates due to stress occurs as the pressure plates are fastened together using fastening nuts and bolts for stack assembly.

The deformation of the pressure plates occurs because the pressure plates are unable to withstand the stress as the nuts are fastened. Accordingly, sealing of each of the fuel cells between the pressure plates is disrupted due to the deformation of the pressure plates, thereby deteriorating the performance of the fuel cells and shortening the lifetime of the fuel cells. Deformation of pressure plates is particularly severe when a stack has pressure plates having a thickness of 2 mm or less.

### SUMMARY OF THE INVENTION

The present invention provides a fuel cell system and a strengthened stack formed by enhancing a structure of end plates supporting and fixing a multi-layered plurality of fuel cells at both sides of the fuel cells. The present invention has a structure having ribs formed on the end plates.

A stack for a fuel cell system including at least one electricity generation unit, the at least one electricity generation unit having a membrane-electrode assembly and a separator disposed on at least one planar surface of the membrane-electrode assembly. The at least one electricity generation unit has an input end and an output end. An input end plate is disposed adjacent to the input end and an output end plate is disposed adjacent to the output end, the input end plate having reinforcement ribs formed on an input plate surface and the output end plate having reinforcement ribs formed on an output plate surface.

In addition, the stack may further include a plurality of fastening bolts, passing through the outermost parts of the two end plates for fastening the electricity generation units, and nuts combining with threads on both ends of the plurality of fastening bolts for tightening the two end plates.

In addition, each of the reinforcement ribs may be formed along an edge of each outer surface of the end plates.

In addition, each of the reinforcement ribs may be formed in a diagonal direction of the end plates.

In another embodiment of the present invention, there is provided a fuel cell system including a stack generating electrical energy through an electrochemical reaction of hydrogen and oxygen, a fuel supply source supplying fuel containing hydrogen to the stack, and an oxygen supply source supplying oxygen to the stack. The stack includes at least one electricity generation unit, the at least one electricity generation unit having a membrane-electrode assembly and a separator disposed on at least one planar surface of the membrane-electrode assembly. The at least one electricity generation unit has an input end and an output end. An input end plate is disposed adjacent to the input end and an output end plate is disposed adjacent to the output end, the input end plate having reinforcement ribs formed on an input plate surface and the output end plate having reinforcement ribs formed on an output plate surface.

In the embodiment above, the stack may include a plurality of electricity generation units and the stack has a multi-layered structure of a plurality of the electricity generation units.

In addition, the fuel supply source may include a fuel tank storing fuel containing hydrogen and a fuel pump connected to the fuel tank.

In addition, the fuel supply source may include a reformer connected to the electricity generation units and the fuel tank, wherein the reformer is supplied with fuel from the fuel tank to generate hydrogen gas and supplies the hydrogen gas to the electricity generation units.

In addition, the oxygen supply source includes an air pump inhaling air and supplying the inhaled air to the electricity generation units.

In addition, one of the separators may be disposed in tight contact with one surface of a membrane-electrode assembly and is provided with a hydrogen pathway through which hydrogen gas is supplied to the membrane-electrode assembly and another separator is disposed in tight contact with the other side of the membrane-electrode assembly and is provided with an air pathway through which air is supplied to the membrane-electrode assembly.

In yet another embodiment of the present invention, a method of improving the resistance to bending of a stack for a fuel cell system is provided, the stack including at least one electricity generation unit. The at least one electricity generation unit has a membrane-electrode assembly and a separator disposed on at least one planar surface of the membrane-electrode assembly, the at least one electricity generation unit having an input end and an output end. The method includes locating at the input end of the at least one electricity generation unit an input end plate having a plurality of reinforcement ribs and locating at the output end of the at least one electricity generation unit an output end plate having a plurality of reinforcement ribs.

### BRIEF DESCRIPTION OF THE DRAWINGS

FIG. 1 is a schematic diagram illustrating a fuel cell system according to an embodiment of the present invention.

FIG. 2 is a perspective exploded view of a stack according to an embodiment of the present invention.

FIGS. 3A and 3B are schematic partial front views of a stack according to an embodiment of the present invention.

FIGS. 4A and 4B are schematic partial front views of a stack according to another embodiment of the present invention.

FIG. 5 is schematic partial side view of a stack according to a further embodiment of the present invention.

FIG. 6 is a perspective view of a stack according to still another embodiment of the present invention.

FIG. 7 is schematic partial side view of a stack according to yet another embodiment of the present invention.

### DETAILED DESCRIPTION

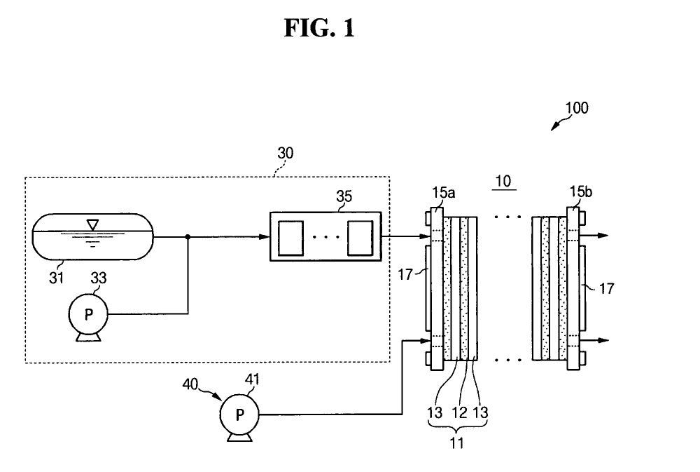

Referring to FIG. 1, the fuel cell 100 according to an embodiment of the present invention employs a polymer electrolyte membrane fuel cell (PEMFC) that reforms a fuel containing hydrogen to generate hydrogen gas and performs an electro-chemical reaction of the hydrogen gas and an oxidant gas to generate electrical energy.

In the fuel cell system 100, the fuel used for generating electricity may be a liquid or a gaseous fuel such as methanol, ethanol, and natural gas, or hydrogen gas generated from reforming the liquid or gaseous fuel. In the described exemplary embodiment, liquid fuel is used for convenience of description.

In the fuel cell system 100, an oxygen gas stored in a separate storage unit or air containing oxygen may be used as the oxidant gas to react with the hydrogen gas.

The fuel cell system 100 includes a stack 10 generating electrical energy through an electrochemical reaction of hydrogen and the oxygen, a fuel supply source 30 generating hydrogen gas from the aforementioned fuel and supplying hydrogen gas to the stack 10, and an oxygen supply source 40 supplying air to the stack 10.

The stack 10 is disposed in connection with the fuel supply source 30 and the oxygen supply source 40. The stack 10 is supplied with hydrogen gas from the fuel supply source 30 and air from the oxygen supply source 40, and performs an electro-chemical reaction of the hydrogen gas and oxygen contained in the air to generate electrical energy.

The fuel supply source 30 includes a fuel tank 31 for storing the fuel, a fuel pump 33 for pumping the stored fuel in the fuel tank 31, and a reformer 35 supplied with the fuel from the fuel tank 31, generating hydrogen gas from the supplied fuel, and supplying the hydrogen gas to the stack 10.

The oxygen supply source 40 includes an air pump 41 to supply air to the stack 10.

The reformer 35 included in the fuel supply source 30 has a structure of a general reformer that generates hydrogen gas from the aforementioned fuel through a catalytic reaction that occurs by applying thermal energy and decreases a level of carbon monoxide contained in the hydrogen gas. In other words, the reformer 35 generates hydrogen gas from the fuel through a catalytic reaction such as a steam reforming reaction, a partial oxidation reaction, or an auto-thermal reaction. In addition, the reformer 35 may decrease the level of carbon monoxide contained in the hydrogen gas through a catalysis reaction such as a water gas shift process or a selective oxidation process, or through a method of hydrogen purification using a separation membrane.

Alternatively, the fuel cell system 100 according to an embodiment of the present invention may employ a type of direct methanol fuel cell (DMFC) generating electricity by supplying fuel directly to the stack 10. A fuel cell of this DMFC type is different from the PEMFC type fuel cell since the DMFC does not require the reformer 35 illustrated in FIG. 1.

Although a fuel cell system employing the PEMFC type will now be described, the present invention is not limited thereto.

When hydrogen gas generated from the reformer 35 and air inhaled by the air pump 41 are supplied to the stack 10 in an operation of the fuel cell system 100 according to the present invention, electrical energy is generated in the stack 10 through an electrochemical reaction of the hydrogen gas and oxygen contained in the air.

An embodiment of the stack 10 will now be described in detail with reference to the attached drawings.

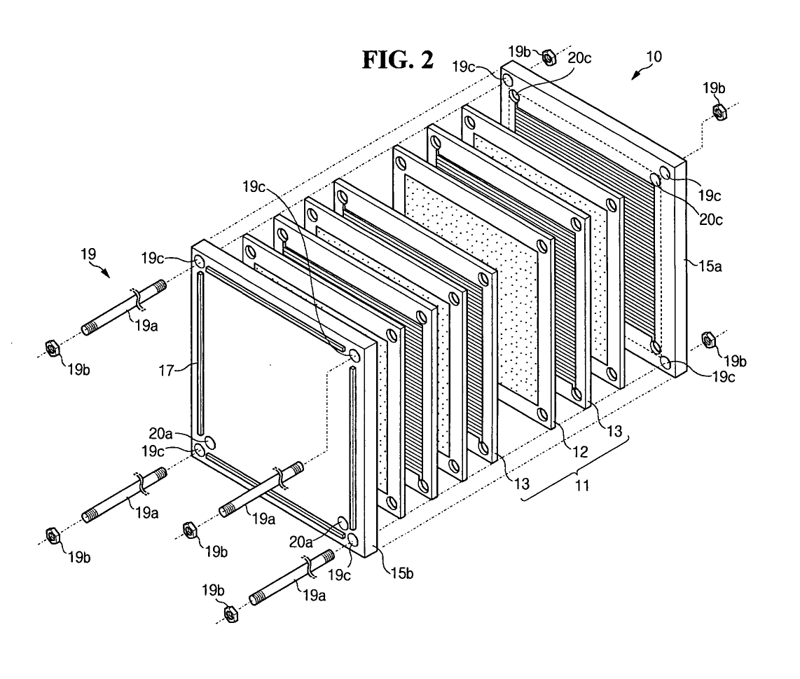

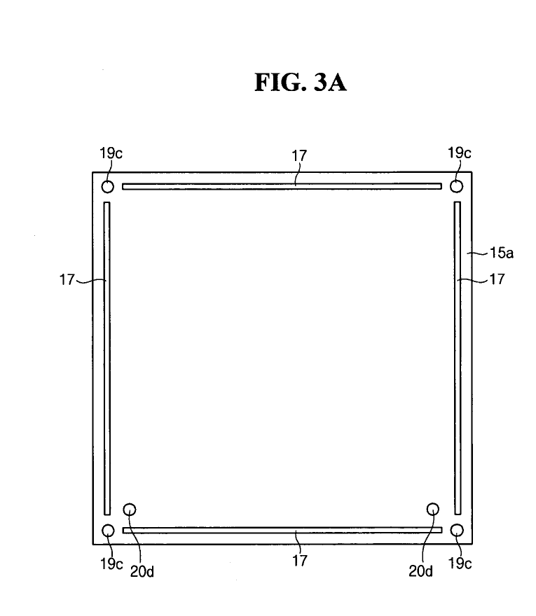

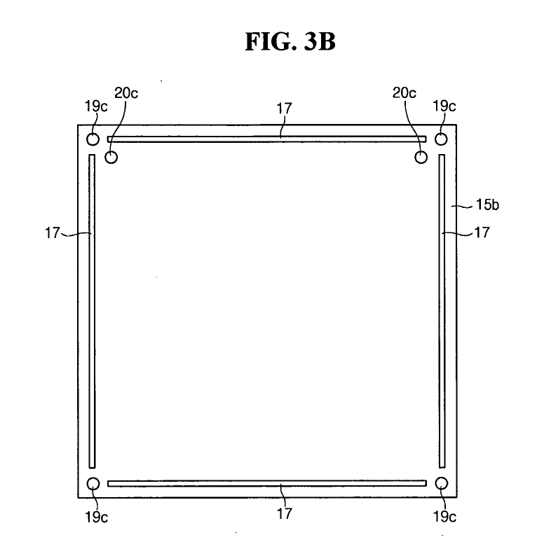

Referring to FIGS. 2, 3A and 3B, the stack 10 employed in the fuel cell system 100 according to the embodiment of the present invention includes an electricity generation unit 11 having a membrane-electrode assembly (MEA) 12 and a separator 13 disposed on a generally planar surface of the MEA 12. Accordingly, a stack 10 having a multi-layered structure according to the embodiment is formed by consecutively layering a plurality of electricity generation units 11 described above.

In the stack 10, each MEA 12 interposed between two separators 13, includes anode and cathode electrodes (not shown) disposed on each side of the MEA and an electrolyte membrane (not shown) interposed between the two electrodes. In the anode electrode, hydrogen gas is decomposed into protons (hydrogen ions) and electrons through an oxidation reaction of hydrogen gas supplied through one of the separators 13. In the cathode electrode, heat of a predetermined temperature and moisture are generated through a reduction reaction of oxygen contained in air supplied through the other separator 13, with the protons transferred from the anode electrode of the MEA 12 and electrons transferred from an anode electrode of an adjacent MEA 12. Through the electrolyte membrane, which is made of a solid polymer electrolyte having a thickness of between about 50 to 200 μm, the hydrogen ions generated in the anode electrode are transferred to the cathode electrode. In other words, ion exchange is performed in the electrolyte membrane.

The separators 13 are disposed so as to contact both planar (as opposed to edge) surfaces of the MEA 12 therebetween, and so as to allow a hydrogen pathway and an air pathway to be formed. The hydrogen pathway is disposed on the anode electrode side of the MEA 12 and provides a path through which hydrogen gas supplied from the reformer 35 is transferred to the anode electrode. The air pathway is disposed on the cathode electrode side of the MEA 12 and provides a path through which oxygen contained in the air supplied from the air pump 41 is transferred to the cathode electrode. In addition, the separators 13 function as a conductor connecting the anode electrode and the cathode electrode in series.

In each separator 13, the hydrogen pathway may be formed on one side of the separator 13 and the air pathway may be formed on the other side of the separator 13. Alternatively, the hydrogen pathway and the air pathway may be respectively formed on one side of the separators 13 that are disposed on either side of the MEA 13. In the separators 13, the hydrogen pathway and the air pathway may be formed by molding graphite or a carbon composite, or by compression molding a plate made of metal materials.

In FIG. 2, a detailed structure of the hydrogen and air pathways for supplying and circulating the hydrogen gas and the air is omitted, and a conventional structure in which the hydrogen gas and the air are supplied to the hydrogen and air pathways at inputs 20c and circulated, and the non-reacted remaining hydrogen gas and air are discharged at outputs 20d, may be employed.

In an operation of the embodiment of the fuel cell system 100, air containing oxygen is supplied to the cathode electrodes while the hydrogen gas is supplied to the anode electrodes of the MEAs 12 through the separators 13. Accordingly, in the anode electrodes, hydrogen gas is decomposed into electrons and protons (hydrogen ions). The protons are transferred to the cathode electrodes through the electrolyte membranes of the MEAs 12, while the electrons are moved to cathode electrodes of adjacent MEAs 12 through the separators 13. Accordingly, a current is generated by the flow of the electrons, and in the cathode electrodes, heat and moisture are generated through a combination reaction of the transferred protons and electrons with oxygen.

In the embodiment of the present invention, an input end plate 15a and an output end plate 15b for fixing a multi-layered plurality of electricity generation units 11 are disposed at an input end and an output end of the stack 10, respectively. The input/output end plates 15a, 15b may include a current collecting unit collecting electrical energy generated by the electricity generation units 11.

In the present embodiment, the input/output end plates 15a, 15b are formed to have a larger area than the electricity generation units 11. In other words, the input/output end plates 15a, 15b have a structure in which edges of the input/output end plates 15a, 15b extend past edges of the electricity generation units 11. A fastening unit 19 is installed through the extended parts of the input/output end plates 15a, 15b to combine the stack components by fastening the two end plates 15a, 15b.

The fastening unit 19 is used to fasten the fuel cell system 100 together by pressing the plurality of electricity generation units 11 at a predetermined pressure to prevent leakage of the hydrogen gas and the air supplied to the electricity generation units 11. The fastening unit 19 includes fastening bolts 19a which pass through a plurality of fastening holes 19c formed on marginal part A of the input/output end plates 15a, 15b, and nuts 19b, fastened to threads formed on both ends of the fastening bolts 19a to fix the input/output end plates 15a, 15b.

Accordingly, the stack 10 may be fixed at an appropriate pressure by fastening the nuts 19b to both threaded ends of the fastening bolts 19a passing through the fastening holes 19c to press both sides of the input/output end plates 15a, 15b.

The input/output end plates 15a, 15b each may have a structure in which reinforcement ribs 17 are formed along the edges of the outer sides. The ribs 17 are formed to protrude from surfaces of the input/output end plates 15a, 15b and there is no limitation on a height and a thickness of the ribs 17. Each rib 17 may be disposed linearly along an edge of an outer surface of the input/output end plates 15a, 15b between the fastening holes 19c formed at corners of the input/output end plates 15a, 15b. Each rib 17 may have a length such that the rib does not interfere with the nuts 19b around the fastening holes 19c or any input/output lines coupled to inputs/outputs 20c, 20d.

In addition, the ribs 17 may have a rectangular cross-sectional form, but are not limited thereto and may have various forms, such as a convex cross-section.

As described above, the ribs 17 are formed as protrusions integrally formed with the input/output end plates 15a, 15b. When pressure is applied to the input/output end plates 15a, 15b by fastening the nuts 19b to the fastening bolts 19a, the input/output end plates 15a, 15b are stressed. When the pressure is applied, the ribs 17 increase the resistance to bending of the input/output end plates 15a, 15b so that deformation of the input/output end plates 15a, 15b may be minimized.

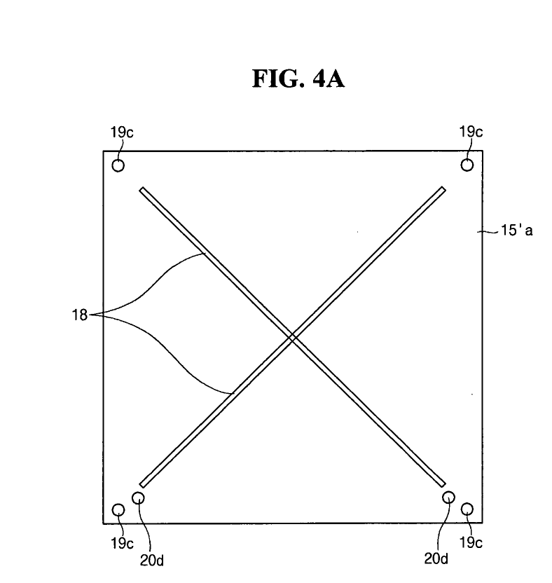

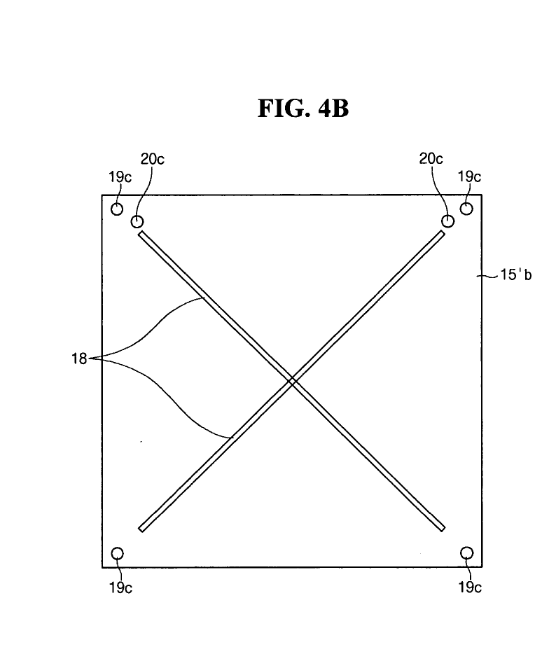

FIGS. 4A and 4B are schematic front views showing an end plate according to another embodiment of the present invention. Referring to FIGS. 4A and 4B, reinforcement ribs 18 are formed as protrusions from outer planar (as opposed to edge) surfaces of the input/output end plates 15′a, 15′b to form an integral body with the input/output end plates 15′a, 15′b. The ribs 18 extend diagonally between corners of the input/output end plates 15′a, 15′b. There is no limitation on a height and a thickness of the ribs 18.

In addition, the ribs 18 are disposed linearly between one fastening hole 19c formed at one corner of the rectangular end plates 15′a, 15′b and another fastening hole 19c disposed in a diagonal direction. The ribs 18 may have a length such that neither end of the ribs 18 interferes with the nuts 19b around the fastening holes 19c or any input/output lines coupled to inputs/outputs 20c, 20d. In addition, the ribs 18 may have a rectangular cross-section, but are not limited thereto and the ribs 18 may also have other cross-sections such as a convex cross-section.

As described above, in the fuel cell system according to exemplary embodiments of the present invention, excessive deformation of the input/output end plates can be prevented by decreasing concentration of the stress from nuts fixing the input/output end plates.

Although exemplary embodiments of the present invention have been described, the present invention is not limited to the described embodiments but rather may be modified in various forms without departing from the scope of the appended claims, the detailed description, and the accompanying drawings of the present invention.

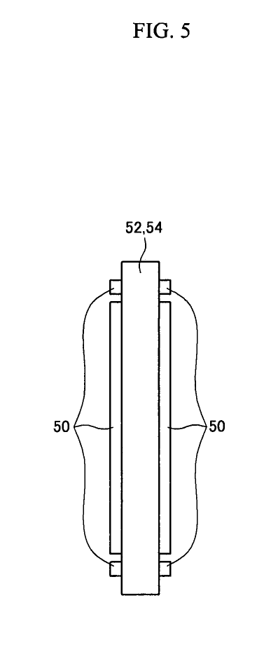

For example, as shown FIG. 5, reinforcement ribs 50 may be formed on both sides of an input end plate 52 and an output end plate 54.

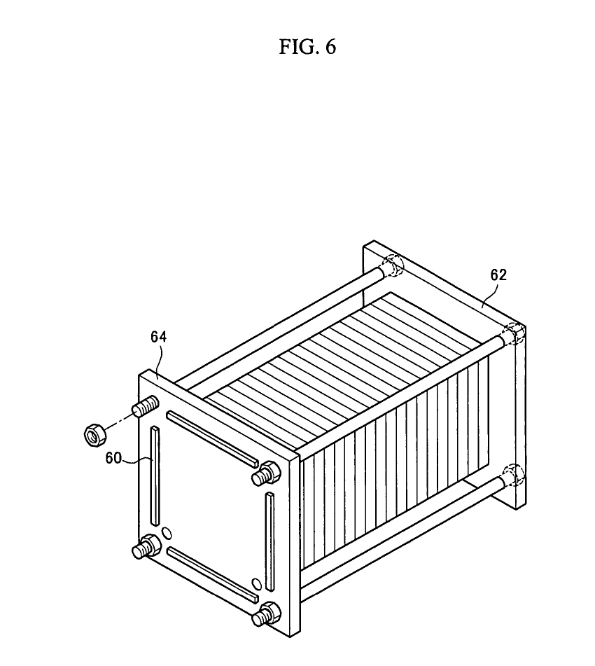

Additionally, as shown FIG. 6, reinforcement ribs 60 may be formed on only one of an input end plate 62 and an output end plate 64. FIG. 6 shows the reinforcement ribs 60 formed on an exterior surface of the output end plate 64.

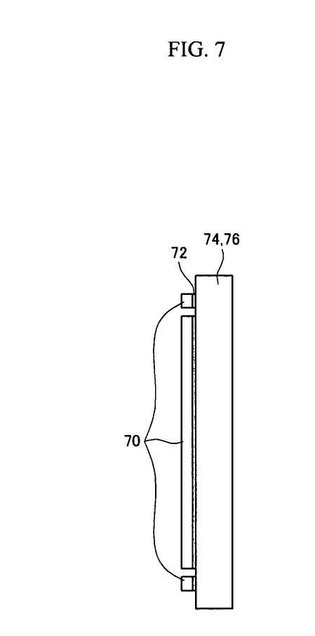

Furthermore, as shown FIG. 7, reinforcement ribs 70 may be combined on surfaces of an input end plate 74 and an output end plate 76 by bonding type with bonding materials.

What is claimed is:

1. A stack for a fuel cell system comprising:
at least one electricity generation unit, the at least one electricity generation unit including a membrane-electrode assembly and a separator disposed on at least one planar surface of the membrane-electrode assembly, the at least one electricity generation unit having an input end and an output end; and
an input end plate disposed adjacent to the input end and an output end plate disposed adjacent to the output end, the input end plate having reinforcement ribs formed on an input plate surface and the output end plate having reinforcement ribs formed on an output plate surface.

2. The stack of claim 1, further comprising:
a plurality of fastening bolts passing through the input end plate and the output end plate for fastening together the at least one electricity generation unit, each fastening bolt having an input threaded end and an output threaded end; and
a plurality of nuts threadable on the input threaded end and the output threaded end of the plurality of fastening bolts.

3. The stack of claim 1, wherein the reinforcement ribs are formed on at least one of an input plate exterior surface and an input plate inner surface, and on at least one of an output plate exterior surface and an output plate inner surface,.

4. The stack of claim 1, wherein the reinforcement ribs are formed adjacent to an exterior planar surface edge of the input end plate and adjacent to an exterior planar surface edge of the output end plate.

5. The stack of claim 1, wherein the reinforcement ribs are formed adjacent to each exterior planar surface edge of the input end plate and adjacent to each exterior planar surface edge of the output end plate.

6. The stack of claim 1, wherein the reinforcement ribs are linear.

7. The stack of claim 1, wherein the reinforcement ribs have rectangular cross-sections.

8. The stack of claim 1, wherein the reinforcement ribs extend diagonally from a first corner of the input end plate to a second corner of the input end plate or from a first corner of the output end plate to a second corner of the output end plate.

9. The stack of claim 1, wherein the reinforcement ribs are integrally formed on the input plate surface and the output plate surface.

10. The stack of claim 1, wherein the reinforcement ribs are respectively combined on the input plate surface and the output plate surface by bonding materials.

11. A fuel cell system comprising:
a stack generating electrical energy through an electro-chemical reaction of hydrogen and oxygen;
a fuel supply source supplying fuel containing hydrogen to the stack; and
an oxygen supply source supplying oxygen to the stack,
wherein the stack includes at least one electricity generation unit, the at least one electricity generation unit having a membrane-electrode assembly and a separator disposed on at least one planar surface of the membrane-electrode assembly, the at least one electricity generation unit having an input end and an output end, and an input end plate disposed adjacent to the input end and an output end plate disposed adjacent to the output end, the input end plate having reinforcement ribs formed on an input plate surface and the output end plate having reinforcement ribs formed on an output plate surface.

12. The fuel cell system of claim 11, wherein the stack comprises a plurality of electricity generation units having a multi-layered structure.

13. The fuel cell system of claim 11, wherein the fuel supply source includes a fuel tank for storing the fuel containing hydrogen and a fuel pump connected to the fuel tank.

14. The fuel cell system of claim 13,
wherein the fuel supply source includes a reformer connected to the at least one electricity generation unit and the fuel tank;
wherein the reformer is supplied with fuel from the fuel tank to generate hydrogen gas; and
wherein the reformer supplies the hydrogen gas to the at least one electricity generation unit.

15. The fuel cell system of claim 11, wherein the oxygen supply source comprises an air pump to supply air to the at least one electricity generation unit.

16. The fuel cell system of claim 11,
wherein at least one separator contacts an input planar surface of the membrane-electrode assembly and is provided with a hydrogen pathway through which hydrogen gas is supplied to the membrane-electrode assembly; and
wherein at least one separator contacts an output planar surface of the membrane-electrode assembly and is provided with an air pathway through which the air is supplied to the membrane-electrode assembly.

17. The fuel cell system of claim 11, wherein the reinforcement ribs are formed adjacent to an exterior planar surface edge of the input end plate and adjacent to an exterior planar surface edge the output end plate.

18. The fuel cell system of claim 11, wherein the reinforcement ribs are formed on at least one of an input plate exterior surface and an input plate inner surface, and on at least one of an output plate exterior surface and an output plate inner surface.

19. The fuel cell system of claim 11, wherein the reinforcement ribs are formed adjacent to each exterior planar surface of the input end plate and adjacent to each exterior planar surface of the output end plate.

20. The fuel cell system of claim 11, wherein the reinforcement ribs are linear.

21. The fuel cell system of claim 11, wherein the reinforcement ribs have a rectangular cross-section.

22. The fuel cell system of claim 11, wherein the reinforcement ribs extend diagonally from a first corner of the input end plate to a second corner of the input end plate and from a first corner of the output end plate to a second corner of the output end plate.

23. The fuel cell system of claim 11, wherein the reinforcement ribs are integrally formed on the input plate surface and the output plate surface, respectively.

24. The fuel cell system of claim 11, wherein, in the stack, the reinforcement ribs are respectively combined on the input plate surface and the output plate surface by bonding materials.

25. A stack for a fuel cell system comprising:
at least one electricity generation unit, the at least one electricity generation unit including a membrane-electrode assembly and a separator disposed on at least one planar surface of the membrane-electrode assembly, the at least one electricity generation unit having an input end and an output end;
an input end plate disposed adjacent to the input end and an output end plate disposed adjacent to the output end; and
reinforcement ribs formed on at least one of an input plate surface of the input end plate and an output plate surface of the output end plate.

26. A method of improving the resistance to bending of a stack for a fuel cell system, the stack including at least one electricity generation unit, the at least one electricity generation unit including a membrane-electrode assembly and a separator disposed on at least one planar surface of the membrane-electrode assembly, the at least one electricity generation unit having an input end and an output end, the method comprising:
locating at the input end of the at least one electricity generation unit an input end plate having a plurality of reinforcement ribs; and
locating at the output end of the at least one electricity generation unit an output end plate having a plurality of reinforcement ribs.
